(19) United States
(12) Patent Application Publication
(10) Pub. No.: US 2006/0088746 A1
(43) Pub. Date: Apr. 27, 2006

(54) Passive dual-phase cooling for fuel cell assemblies

(75) Inventors: Phillip E. Tuma, Faribault, MN (US); Krzysztof A. Lewinski, Mahtomedi, MN (US); Mark K. Debe, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/973,021

(22) Filed: Oct. 25, 2004

(51) Int. Cl. H01M 8/04; H01M 2/02

(52) U.S. Cl. 429/26; 429/34

(57) ABSTRACT

A cooling apparatus for a fuel cell assembly includes a heat transfer fluid and at least one fluid flow field plate configured to facilitate essentially passive, two-phase cooling for an membrane electrode assembly (MEA) as the MEA is subject to changes in heat flux to the heat transfer fluid from about 0 W/cm² to about 1.5 W/cm². The flow field plate includes fluid flow channels that have a channel depth, a channel spacing, a channel length, and a channel width, which are dimensioned to promote nucleated boiling of the heat transfer fluid below a critical heat flux and to prevent dryout as the heat transfer fluid passes along the length of the channels. The channels may include coatings and/or features, such as microporous or nanostructured coatings, that extend the critical heat flux and preclude dryout at the distal sections of the fluid flow channels.

### FIELD OF THE INVENTION

The present invention relates generally to passive dual-phase cooling arrangements and approaches for fuel cell components and assemblies within a fuel cell stack.

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange member at the center with gas diffusion layers on either side of the proton exchange member. Anode and cathode catalyst layers are respectively positioned at the inside of the gas diffusion layers. This type of fuel cell is often referred to as a PEM fuel cell.

The reaction in a single fuel cell typically produces less than one volt. A plurality of the fuel cells may be stacked and electrically connected in series to achieve a desired voltage. Electrical current is collected from the fuel cell stack and used to drive a load. Fuel cells may be used to supply power for a variety of applications, ranging from automobiles to laptop computers.

The efficacy of fuel cell power systems in many applications depends largely in part on the cooling apparatus that provides thermal management for the fuel cells. In stationary power and traction PEM fuel cell applications, for example, volumetric power densities are driven upward by the need to reduce the stack size. The higher heat densities are usually removed by pumping a dielectric heat transfer liquid through passages within cold plates or bipolar plates that lie between adjacent membrane electrode assemblies (MEAs). As the coolant passes through the stack, it absorbs the heat of reaction and its temperature increases. The coolant is then pumped to some primary heat exchanger where the heat is dissipated to another fluid stream, be it air, water, etc. Because the fluid has not changed phase, this technique is termed “single phase” cooling.

This single phase technique has several distinct disadvantages, including, for example, the need for pumps, plumbing, large quantities of heat transfer fluid, and active controls to regulate stack temperature during startup, or to accommodate changes in heat output and environmental conditions, resulting in added weight and cost. Power consumed by the pump must be provided by the stack and dissipated by its thermal system, thereby reducing available power and increasing the size of the primary heat exchanger.

### SUMMARY OF THE INVENTION

The present invention relates generally to passive dual-phase cooling arrangements and approaches for fuel cell components and assemblies within a fuel cell stack. More particularly, the present invention is directed to such passive dual-phase cooling apparatuses that incorporate surface coatings and/or features that effectively extend the critical heat flux of flow field plate coolant channels and/or improves temperature uniformity over the entire channel length while minimizing channel depth so as to reduce cooling plate thicknesses and reducing coolant requirements and weight. “Critical heat flux” means the heat flux beyond which boiling cannot be sustained because liquid no longer wets the surface. To “extend the critical heat flux” means increasing the value of heat flux beyond which boiling cannot be sustained because liquid no longer wets the surface. The present invention is further directed to such passive dual-phase cooling apparatuses that provide thermal management for fuel cell assemblies, stacks, and power systems that incorporate fuel cells.

In accordance with various embodiments, a fuel cell stack assembly of the present invention includes at least one membrane electrode assembly (MEA) and a cooling apparatus. The cooling apparatus includes a heat transfer fluid and at least one fluid flow-field plate configured to facilitate essentially passive, two-phase cooling for the MEA as the MEA is subject to changes in heat flux to the heat transfer fluid from about 0 W/cm² to about 1.5 W/cm².

The flow field plate includes a number of fluid flow channels that have a channel depth, a channel spacing, a channel length, and a channel width, the width of the channels being less than about 5 mm. The channel width, channel spacing, channel length, and channel depth are dimensioned in accordance with principles of the present invention to promote nucleated boiling of the heat transfer fluid below a critical heat flux and to prevent dryout as the heat transfer fluid passes along the length of the channels. In one implementation, the cooling apparatus maintains a maximum temperature gradient of less than about 0.2° C./cm in a direction of heat transfer fluid flow as the MEA is subject to changes in heat flux to the heat transfer fluid from about 0 W/cm² to about 1.5 W/cm².

The channel width, channel spacing, channel length, and channel depth are preferably dimensioned to promote incipience of the heat transfer fluid at an entry region of the channels and to prevent the heat flux from exceeding the critical heat flux as the heat transfer fluid passes an exit region of the channels. In one configuration, the length of the channels is greater than about 10 cm. In another configuration, the channels have a channel length in a direction of heat transfer fluid flow of about 60 mm to about 230 mm. In a further configuration, the channel spacing is about 1 mm to about 2 mm, and the channel width is about 1 mm to about 3 mm. In yet another configuration, the channel depth may be less than about 1 mm. A ratio of channel length to channel depth may range between about 150 and about 1100.

In a typical implementation, an MEA comprises a surface configured to contact a surface of a flow field plate, and the heat transfer fluid of the cooling apparatus has a boiling point at the operating pressure of less than about 3° C. below a maximum temperature of the MEA surface. The heat transfer fluid may comprises a fluorochemical, a dielectric halocarbon, water or a hydrocarbon.

In some configurations, the fluid flow channels of the flow field plate have inner channel surfaces that incorporate nanostructured features. In other configurations, the fluid flow channels have inner channel surfaces that incorporate microporous features. In certain configurations, the fluid flow channels of the flow field plate have inner channel surfaces that incorporate a coating comprising a substantially planar organic molecule comprising delocalized pi-electrons.

According to another embodiment, a fuel cell stack assembly of the present invention includes at least one MEA and a cooling apparatus comprising at least one flow field plate configured to facilitate essentially passive, two-phase cooling for the MEA. In this embodiment, the flow field plate incorporates fluid flow channels having a channel length defined relative to the direction of coolant flow and a channel depth of less than about 1 mm. The cooling apparatus maintains a maximum temperature gradient of less than about 0.2° C./cm in a direction of coolant flow as the MEA is subject to changes in heat flux to the coolant from about 0 W/cm² to about 1.5 W/cm².

In accordance with a further embodiment, a fuel cell stack assembly of the present invention includes at least one MEA and a cooling apparatus comprising at least one flow field plate configured to facilitate essentially passive, two-phase cooling for the MEA. In this embodiment, the flow field plate incorporates fluid flow channels having inner channel surfaces. Each of the inner channel surfaces comprises nanostructured features. The cooling apparatus maintains a maximum temperature gradient of less than about 0.2° C./cm in a direction of coolant flow as the MEA is subject to changes in heat flux to the coolant from about 0 W/cm² to about 1.5 W/cm².

The nanostructured features may comprise uniformly oriented nanostructures. The nanostructured features may comprise nanostructures having a predefined geometric shape, such as rods, cones, cylinders, pyramids, tubes, flakes or other shapes. The inner channel surfaces may comprise in excess of about 1 million nanostructures/cm², such as in excess of about 1 billion nanostructures/cm², for example. The nanostructured features may have lengths ranging from about 0.1 micron to about 3 micron, but may be a long as about 6 micron.

According to another embodiment, a fuel cell stack assembly includes at least one MEA and a cooling apparatus comprising at least one fluid flow field plate configured to facilitate essentially passive, two-phase cooling for the MEA. In this embodiment, the flow field plate comprises fluid flow channels having inner channel surfaces. Each of the inner channel surfaces comprising microporous features. The cooling apparatus maintains a maximum temperature gradient of less than about 0.2° C./cm in a direction of coolant flow as the MEA is subject to changes in heat flux to the coolant from about 0 W/cm² to about 1.5 W/cm². “Microporous features” means micropores surrounded by an assembly of microparticles. The microparticles preferably comprise micron scale sized particles, such as metal, silica, ceramic or diamond. Particles forming micropores may be organic (e.g., latex spheres), or other kind of heteropolymer or heterocyclic material.

In accordance with yet another embodiment, a fuel cell stack assembly of the present invention includes at least one MEA and a cooling apparatus comprising at least one flow field plate configured to facilitate essentially passive, two-phase cooling for the MEA. In this embodiment, the flow field plate incorporates fluid flow channels having inner channel surfaces. Each of the inner channel surfaces incorporates a coating that includes a substantially planar organic molecule comprising delocalized pi-electrons. The cooling apparatus maintains a maximum temperature gradient of less than about 0.2° C./cm in a direction of coolant flow as the MEA is subject to changes in heat flux to the coolant from about 0 W/cm² to about 1.5 W/cm². The organic molecule may comprise chains or rings over which a density of the pi-electrons is extensively delocalized. For example, the coating may comprise van der Waals solids.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1a is an illustration of a fuel cell and its constituent layers;

FIG. 1b illustrates a unitized cell assembly having a monopolar configuration in accordance with an embodiment of the present invention;

FIG. 1c illustrates a unitized cell assembly having a monopolar/bipolar configuration in accordance with an embodiment of the present invention;

FIG. 2a is a block diagram of a passive dual-phase cooling apparatus for cooling a power system employing fuel cells;

FIG. 2b shows a coolant channel arrangement provided on a bipolar flow field plate that is well suited for implementing embodiments of the present invention;

FIG. 2c is a partial perspective view of several coolant channels of the flow field plate shown in FIG. 2b;

FIG. 3 is a sectional view of two flow field plates of the type shown in FIGS. 2b and 2c with respective coolant channel arrangements in a contacting relationship;

FIG. 4 is a graph of coolant channel temperature vs. coolant channel length that illustrates the impact of using channel depths that are too large or too small;

FIG. 5 is an electron micrograph of a microporous material (e.g., “microporous coating”) well suited for coating coolant channels of a flow field plate in accordance with a passive dual-phase cooling approach of the present invention;

FIG. 6 is a magnified cross section of a microstructured catalyst transfer substrate (MCTS) with organic pigment PR-149 (available under the trade designation “13-4000 PV FAST RED 13” from Clariant, Coventry, R.I.) whiskers on the surface (e.g., “nanostructured” coating), which may be used as a coating for coolant channels of a flow field plate in accordance with a passive dual-phase cooling approach of the present invention;

FIG. 7 is a magnified cross section of an MCTS with platinum coated PR-149 whiskers on the surface, which may be used as a coating for coolant channels of a flow field plate in accordance with a passive dual-phase cooling approach of the present invention;

FIG. 8A shows plots of temperature versus heat flux for (1) uncoated coolant channels, (2) coolant channels implemented to include PR-149 coated microchannels without whiskers or platinum, and (3) coolant channels implemented to include PR-149 coated microchanriels with whiskers, this Figure illustrating the “nanostructured effect” that provides for higher critical heat flux by use of nanostructured coatings in the coolant channels;

FIG. 8B shows the FIG. 8A data plotted in terms of a temperature difference at two channel length locations versus heat flux;

FIG. 9A shows plots of temperature versus heat flux for (1) uncoated coolant channels, (2) coolant channels implemented to include PR-149 coated microchannels without whiskers or platinum, and (3) coolant channels with microchannels implemented using a bare MCTS UV cured acrylate substrate, this Figure illustrating the “van der Waals solids effect” that provides for higher critical heat flux by use of coatings with van der Waals solids in the coolant channels;

FIG. 9B shows the FIG. 9A data plotted in terms of a temperature difference at two channel length locations versus heat flux;

FIG. 10A shows plots of temperature versus heat flux for (1) uncoated coolant channels, (2) coolant channels implemented to include PR-149 coated microchannels with whiskers, and (3) coolant channels implemented to include microchannels with platinum coated whiskers, this Figure reinforcing the effect of van der Waals solids on critical heat flux for a nanostructured coolant channel surface;

FIG. 10B shows the FIG. 10A data plotted in terms of a temperature difference at two channel length locations versus heat flux;

FIG. 11A shows plots of temperature versus heat flux for uncoated coolant channels of varying depth and for microporous coated coolant channels of varying depth, this Figure showing that microporous coated coolant channels provide for higher critical heat flux relative to bare channels for a variety of channel depths;

FIG. 11B shows the FIG. 11A data plotted in terms of a temperature difference at two channel length locations versus heat flux;

FIG. 12A shows plots of temperature versus heat flux for uncoated coolant channels of varying depths and lengths, this Figure showing the effect of channel depth and length on critical heat flux; and

FIG. 12B shows the FIG. 12A data plotted in terms of a temperature difference at two channel length locations versus heat flux.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention is directed to passive dual-phase cooling approaches that remove relatively small heat fluxes from relatively large surfaces in fuel cell devices by boiling. The specific illustrative embodiments described below are for purposes of explanation, and not of limitation.

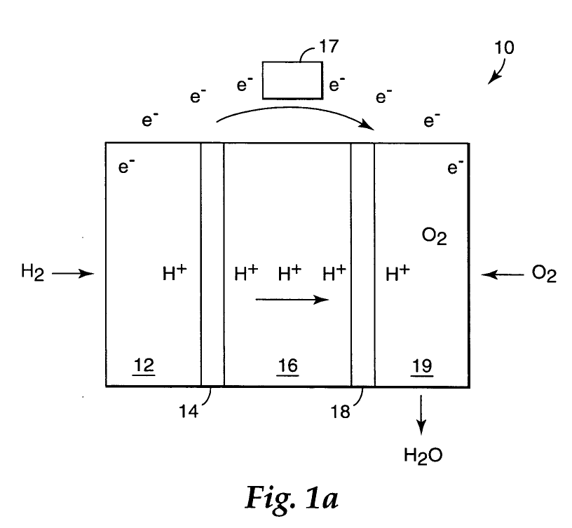

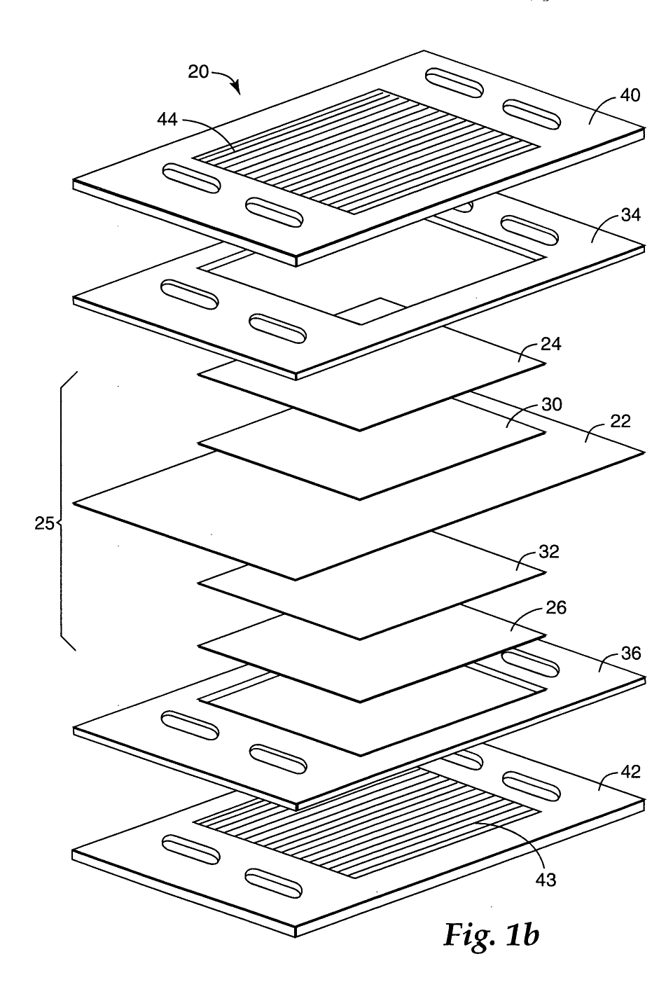

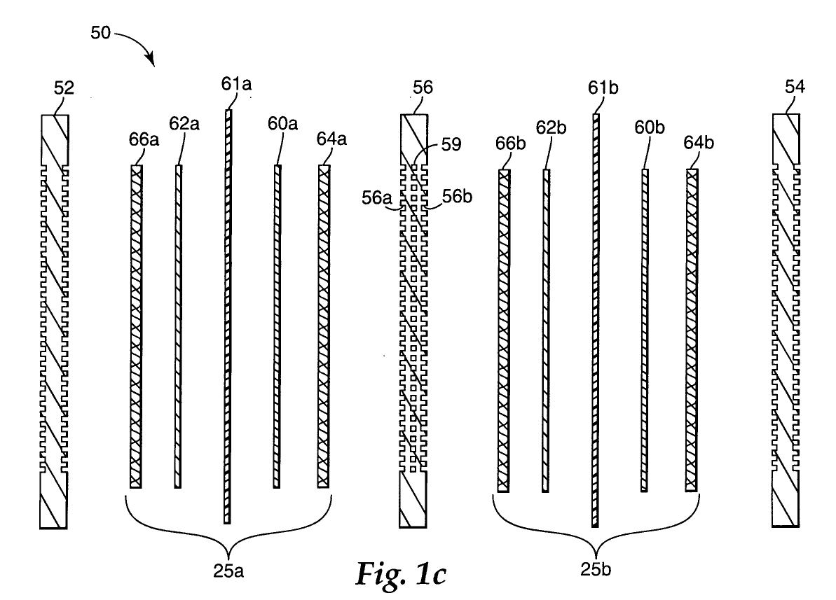

A passive dual-phase cooling methodology of the present invention may be incorporated in fuel cell assemblies and stacks of varying types, configurations, and technologies. A typical fuel cell is depicted in FIG. 1a. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

The fuel cell 10 shown in FIG. 1a includes a first fluid transport layer (FTL) 12 adjacent an anode 14. Adjacent the anode 14 is an electrolyte membrane 16. A cathode 18 is situated adjacent the electrolyte membrane 16, and a second fluid transport layer 19 is situated adjacent the cathode 18. In operation, hydrogen fuel is introduced into the anode portion of the fuel cell 10, passing through the first fluid transport layer 12 and over the anode 14. At the anode 14, the hydrogen fuel is separated into hydrogen ions (H⁺) and electrons (e⁻).

The electrolyte membrane 16 permits only the hydrogen ions or protons to pass through the electrolyte membrane 16 to the cathode portion of the fuel cell 10. The electrons cannot pass through the electrolyte membrane 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second fluid transport layer 19. As the oxygen passes over the cathode 18, oxygen, protons, and electrons combine to produce water and heat.

Individual fuel cells, such as that shown in FIG. 1a, can be packaged as unitized fuel cell assemblies as described below. The unitized fuel cell assemblies, referred to herein as unitized cell assemblies (UCAs), can be combined with a number of other UCAs to form a fuel cell stack. The UCAs may be electrically connected in series with the number of UCAs within the stack determining the total voltage of the stack, and the active surface area of each of the cells determines the total current. The total electrical power generated by a given fuel cell stack can be determined by multiplying the total stack voltage by total current.

A number of different fuel cell technologies can be employed to construct UCAs in accordance with the principles of the present invention. For example, a UCA packaging methodology of the present invention can be employed to construct proton exchange membrane (PEM) fuel cell assemblies. PEM fuel cells operate at relatively low temperatures (about 175° F./80° C.), have high power density, can vary their output quickly to meet shifts in power demand, and are well suited for applications where quick startup is required, such as in automobiles for example.

Alternately, the present invention may be used in non-UCA fuel cell stacks, such as a fuel cell stack that includes bipolar plates (BPP's) stacked alternately with MEA's.

The proton exchange membrane used in a PEM fuel cell is typically a thin solid polymer electrolyte sheet that allows hydrogen ions to pass through it. The membrane is typically coated on both sides with highly dispersed metal or metal alloy particles (e.g., platinum or platinum/ruthenium) that are active catalysts. The electrolyte used is typically a solid perfluorinated sulfonic acid polymer. Use of a solid electrolyte is advantageous because it reduces corrosion and electrolyte containment problems.

Hydrogen is fed to the anode side of the fuel cell where the catalyst promotes the hydrogen atoms to release electrons and become hydrogen ions (protons). The electrons travel in the form of an electric current that can be utilized before it returns to the cathode side of the fuel cell where oxygen has been introduced. At the same time, the protons diffuse through the membrane to the cathode, where the hydrogen ions are recombined and reacted with oxygen to produce water.

A membrane electrode assembly (MEA) is the central element of PEM fuel cells, such as hydrogen fuel cells. As discussed above, typical MEAs comprise a polymer electrolyte membrane (PEM) (also known as an ion conductive membrane (ICM)), which functions as a solid electrolyte.

One face of the PEM is in contact with an anode electrode layer and the opposite face is in contact with a cathode electrode layer. Each electrode layer includes electrochemical catalysts, typically including platinum metal. Fluid transport layers (FTLs) facilitate gas transport to and from the anode and cathode electrode materials and conduct electrical current.

In a typical PEM fuel cell, protons are formed at the anode via hydrogen oxidation and transported to the cathode to react with oxygen, allowing electrical current to flow in an external circuit connecting the electrodes. The FTL may also be called a gas diffusion layer (GDL) or a diffuser/current collector (DCC). The anode and cathode electrode layers may be applied to the PEM or to the FTL during manufacture, so long as they are disposed between PEM and FTL in the completed MEA.

Any suitable PEM may be used in the practice of the present invention. Useful PEM thicknesses range between about 200 μm and about 15 μm. The PEM is typically comprised of a polymer electrolyte that is an acid-functional fluoropolymer, such as Nafion® (DuPont Chemicals, Wilmington Del.), Flemion® (Asahi Glass Co. Ltd., Tokyo, Japan), and polymers having a highly fluorinated backbone and recurring pendant groups according to the formula YOSO₂—CF₂—CF₂—CF₂—CF₂—O-[polymer backbone]where Y is H⁺ or another monovalent cation, such as an alkali metal cation. The latter polymers are described in WO2004062019. The polymer electrolytes useful in the present invention are typically preferably copolymers of tetrafluoroethylene and one or more fluorinated, acid-functional comonomers.

Typically, the polymer electrolyte bears sulfonate functional groups. The polymer electrolyte typically has an acid equivalent weight of 1200 or less, more typically 1100, and most typically about 1000. Equivalent weights as low as 800 or even 700 might be used.

Any suitable FTL may be used in the practice of the present invention. Typically, the FTL is comprised of sheet material comprising carbon fibers. The FTL is typically a carbon fiber construction selected from woven and non-woven carbon fiber constructions. Carbon fiber constructions which may be useful in the practice of the present invention may include: Toray Carbon Paper, SpectraCarb Carbon Paper, AFN non-woven carbon cloth, Zoltek Carbon Cloth, and the like. The FTL may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention, including platinum blacks or fines, ink containing carbon-supported catalyst particles (as described in US20040107869 and herein incorporated by reference), or nanostructured thin film catalysts (as described in U.S. Pat. No. 6,482,763 and U.S. Pat. No. 5,879,827, both incorporated herein by reference). The catalyst may be applied to the PEM or the FTL by any suitable means, including both hand and machine methods, including hand brushing, notch bar coating, fluid bearing die coating, wire-wound rod coating, fluid bearing coating, slot-fed knife coating, three-roll coating, vacuum coating, screen printing or decal transfer. Coating may be achieved in one application or in multiple applications.

Direct methanol fuel cells (DMFC) are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at a temperature between 120-190° F./49-88° C. A direct methanol fuel cell can be subject to UCA packaging in accordance with the principles of the present invention.

Referring now to FIG. 1b, there is illustrated an embodiment of a UCA implemented in accordance with a PEM fuel cell technology. As is shown in FIG. 1b, a membrane electrode assembly (MEA) 25 of the UCA 20 includes five component layers. A PEM layer 22 is sandwiched between a pair of fluid transport layers 24 and 26, such as diffuse current collectors (DCCs) or gas diffusion layers (GDLs) for example. An anode catalyst 30 is situated between a first FTL 24 and the membrane 22, and a cathode catalyst 32 is situated between the membrane 22 and a second FTL 26.

In one configuration, a PEM layer 22 is fabricated to include an anode catalyst coating 30 on one surface and a cathode catalyst coating 32 on the other surface. This structure is often referred to as a catalyst-coated membrane or CCM. According to another configuration, the first and second FTLs 24, 26 are fabricated to include an anode and cathode catalyst coating 30, 32, respectively. In yet another configuration, an anode catalyst coating 30 can be disposed partially on the first FTL 24 and partially on one surface of the PEM 22, and a cathode catalyst coating 32 can be disposed partially on the second FTL 26 and partially on the other surface of the PEM 22.

The FTLs 24, 26 are typically fabricated from a carbon fiber paper or non-woven material or woven cloth. Depending on the product construction, the FTLs 24, 26 can have carbon particle coatings on one side. The FTLs 24, 26, as discussed above, can be fabricated to include or exclude a catalyst coating.

In the particular embodiment shown in FIG. 1b, MEA 25 is shown sandwiched between a first edge seal system 34 and a second edge seal system 36. The edge seal systems 34, 36 provide the necessary sealing within the UCA package to isolate the various fluid (gas/liquid) transport and reaction regions from contaminating one another and from inappropriately exiting the UCA 20, and may further provide for electrical isolation and hard stop compression control between flow field plates 40, 42.

Flow field plates 40 and 42 are positioned adjacent the first and second edge seal systems 34 and 36, respectively. Each of the flow field plates 40, 42 includes a field of gas flow channels 43 and ports through which hydrogen and oxygen feed fuels pass. The flow field plates 40, 42 also incorporate coolant channels and ports configured to facilitate passive dual-phase cooling in accordance with the present invention. The coolant channels are incorporated on surfaces of the flow field plates 40, 42 opposite the surfaces incorporating the gas flow channels 43.

In the configuration depicted in FIG. 1b, flow field plates 40, 42 are configured as monopolar flow field plates, in which a single MEA 25 is sandwiched there between. The flow field in this and other embodiments may be a low lateral flux flow field as disclosed in commonly owned U.S. Pat. No. 6,780,536, which is incorporated herein by reference.

FIG. 1c illustrates a UCA 50 which incorporates multiple MEAs 25 through employment of one or more bipolar flow field plates 56. In the configuration shown in FIG. 1c, UCA 50 incorporates two MEAs 25a and 25b and a single bipolar flow field plate 56, which incorporates integral cooling channels 59. MEA 25a includes a cathode 62a/membrane 61a/anode 60a layered structure sandwiched between FTLs 66a and 64a. FTL 66a is situated adjacent a flow field end plate 52, which may be configured as a monopolar flow field plate or a bipolar plate, with integral cooling channels 59 as is shown for bipolar plate 56. FTL 64a is situated adjacent a first flow field surface 56a of bipolar flow field plate 56. Similarly, MEA 25b includes a cathode 62b/membrane 61b/anode 60b layered structure sandwiched between FTLs 66b and 64b. FTL 64b is situated adjacent a flow field end plate 54, which may be configured as a monopolar flow field plate or a bipolar plate, with integral cooling channels 59 as is shown for bipolar plate 56. FTL 66b is situated adjacent a second flow field surface 56b of bipolar flow field plate 56.

The UCA configurations shown in FIGS. 1b and 1c are representative of two particular arrangements that can be implemented for use in the context of passive dual-phase cooling in accordance with the present invention. These two arrangements are provided for illustrative purposes only, and are not intended to represent all possible configurations coming within the scope of the present invention. Rather, FIGS. 1b and 1c are intended to illustrate various components that can be selectively incorporated into a particular fuel cell assembly design.

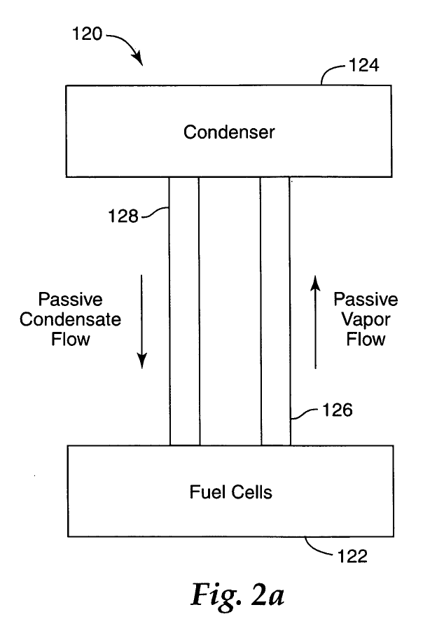

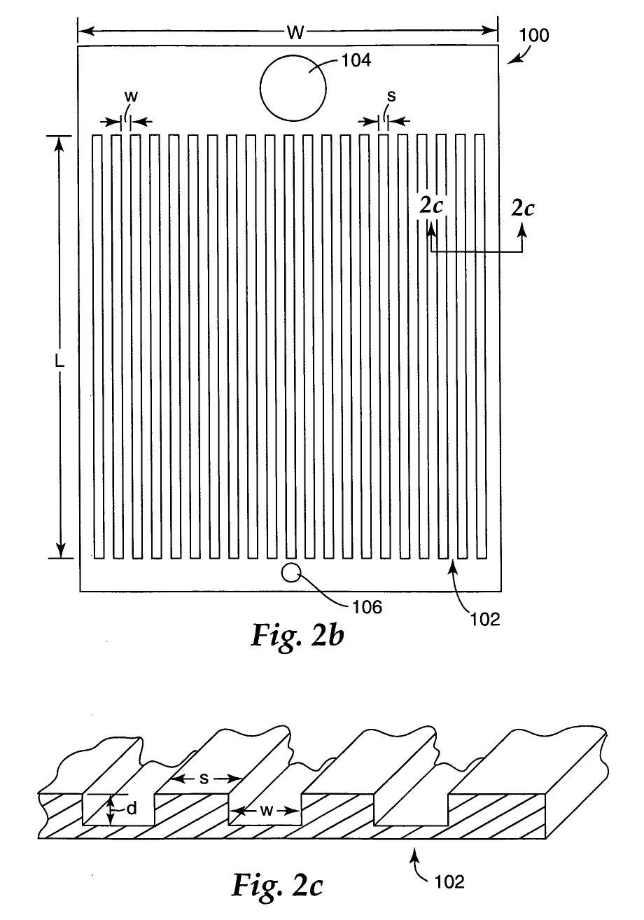

In accordance with the present invention, an alternative approach to single-phase cooling of fuel cell assemblies, stacks, and power systems involves passive two-phase or thermosyphon cooling. In the context of a power system 120 that incorporates fuel cells 122, and as shown in the generalized depiction of FIG. 2a, a coolant is passed through the fuel cells 122 (e.g., fuel cell stack, but could be an individual fuel cell) and is allowed to boil, thereby removing the heat of reaction by a latent process. Vapor evolved from the fuel cell stack 122 flows through a conduit 126 passively to a condenser 124. Condensate flows under gravity from the condenser 124 back to the fuel cell stack 122 via conduit 128 as shown in FIG. 2a. Variations of the generalized cooling approach depicted in FIG. 2a and other related cooling methodologies are described in U.S. Pat. Nos. 6,355,368; 6,146,779; 5,411,077; 5,064,732; 4,824,740, which are hereby incorporated herein by reference. These and other cooling arrangements directed to two-phase cooling of fuel cell assemblies, stacks, and power systems may advantageously be improved or enhanced by incorporating various features of the present invention.

Implementing a passive two-phase cooling approach for fuel cells according to the present invention provides a number of advantages over conventional cooling approaches. For example, no active controls or pump are required to maintain isothermal operation. Systems can be designed to maintain fuel cell stack temperatures uniform to within relatively tight ranges, such as within 2° C. for example. Coolant channels incorporated in flow field plates may be significantly reduced in thickness/depth. For example, coolant channels as thin as 4-8 mil are readily achievable, which can reduce flow field plate (e.g., bipolar plate) thickness relative to conventional flow field plate configurations. Reductions in flow field plate thickness provides a concomitant reduction in fuel cell stack thickness. Such a system operates at or near atmospheric pressure and is less prone to leakage.

A two-phase cooling system of the present invention provides for an isothermal heat sink or source which operates at a temperature slightly below the MEA temperature. In one implementation, for example, an appropriate heat transfer fluid may have a boiling point at the operating pressure of less than about 3° C. below a maximum temperature of the MEA surface. Such a sink has great potential for controlling the temperature and humidity of input gas streams.

A variety of heat transfer fluids may be used, including water, a hydrocarbon, a fluorochemical, or a dielectric halocarbon. In one configuration, hydrofluoroether fluids, such as 3M NOVEC hydrofluoroether fluids, may be used. These fluids have excellent environmental, health, safety and regulatory properties and do not foul the membrane/catalyst assemblies if they leak into the stack. Such fluids are non-corrosive, thus enabling the use of common materials like aluminum and copper for plumbing and heat exchangers.

In accordance with one embodiment, and with reference to FIGS. 2b and 2c, a fuel cell stack assembly of the present invention includes at least one membrane electrode assembly and a cooling apparatus having at least one flow field plate configured to facilitate essentially passive, two-phase cooling for the MEA. By way of non-limiting example, the active area of the flow field plate 100 shown in FIG. 2b includes a number of fluid flow channels 102 each having a channel length, L, defined relative to coolant flow and a channel depth, d. The coolant channels 102 have a width, w, and channel spacing, s. The flow field plate 100 further includes vapor and condensate ports 104 and 106, respectively. Typically, vapor port 104 is larger than condensate port 106, and more typically vapor port 104 is at least 10 times larger in cross-sectional area than condensate port 106. The cooling apparatus preferably maintains a maximum temperature gradient of less than about 0.2° C./cm in a direction of coolant flow as the MEA is subject to changes in heat flux to the coolant from about 0 W/cm² to about 1.5 W/cm². In other configurations, the cooling apparatus is implemented to maintain a maximum temperature gradient of less than about 0.2° C./cm in the direction of coolant flow as the MEA is subject to changes in heat flux to the cooling from about 0 W/cm² to about 1 W/cm².

According to one configuration, the depth, d, of the coolant channels 102 is preferably less than about 1 mm. For example, the coolant channels 102 may have a depth of less than about 0.7 mm. By way of further example, the coolant channels 102 may have a depth of less than about 0.5 mm. In other configurations, the coolant channels 102 may have a depth of less than about 0.3 mm. In yet other configurations, the coolant channels 102 may have a depth of about 0.1 mm.

In some implementations, the coolant channels 102 may have a channel length, L, greater than about 10 cm. In other implementations, the coolant channels 102 may have a channel length, L, that ranges from about 60 mm to about 230 mm. In one particular configuration, for example, the coolant channels 102 may have a channel spacing, s, of about 1 mm to about 2 mm, a channel width, w, of about 1 mm to about 3 mm, and a channel length, L, ranging from about 60 mm to about 230 mm. A ratio of the channel length, L, to channel depth, d, typically ranges between about 150 and about 1100.

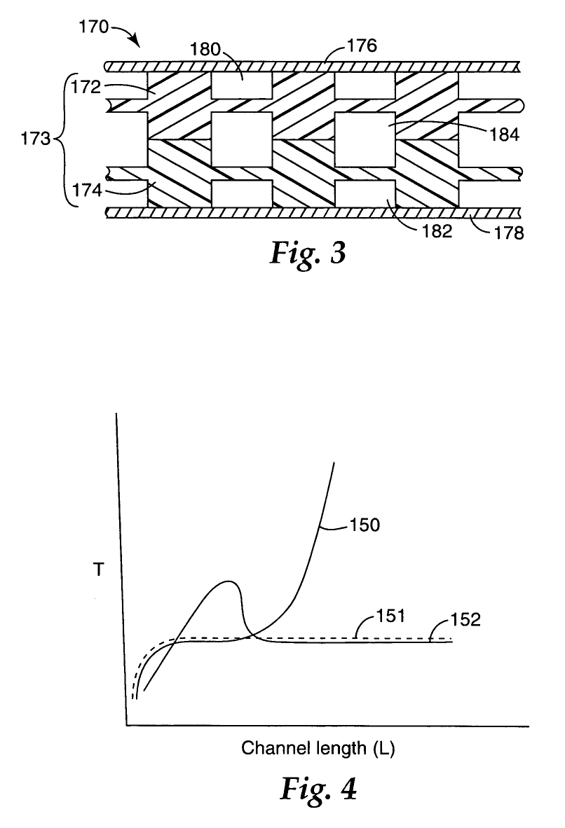

FIG. 3 is a sectional view of an assembly 170 that includes two flow field plates 172, 174 of the type shown in FIGS. 2b and 2c in contact with one another. This arrangement 173 of flow field plates advantageously provides for internal cooling between the two plates 172, 174 in a bipolar flow field plate configuration. A first MEA 176 in shown contacting a surface of flow field plate 172 that includes gas flow channels 180. A second MEA 178 is shown contacting a surface of flow field plate 174 that includes gas flow channels 182. Enclosed cooling channels 184 are formed when the cooling surfaces of flow field plates 172 and 174 are brought into aligned contact within one another.

The heat transfer characteristics of a flow field plate of the type described above can be further enhanced by inclusion of surface coatings and/or features in the coolant channels that advantageously extend the critical heat flux. A variety of surface coatings and features may be employed to effectively increase the critical heat flux. Examples of such surface coatings and features that can be incorporated in the coolant channels of flow field plates include nanostructured features, microporous features, and coatings comprising a substantially planar organic molecule that comprises delocalized pi-electrons, such as are found in van der Waals solids.

One technique for ensuring reliable incipience even at low heat fluxes is the use of a porous coating on the heated surface (i.e., in the coolant channels). These coatings encourage incipience by creating nucleation sites. In saturated boiling from discrete heat sources, coated coolant channel surfaces can exhibit incipience heat fluxes of about 0.2-0.5 W/cm², 80% lower than uncoated surfaces with a 90% reduction in incipience superheat and over a 300% increase in nucleate boiling heat transfer coefficients.

For a prescribed active area width, W, length, L, and heat flux Q″, there are certain values of channel width, w, channel spacing, s, and channel depth, d, that allow proper operation as shown in FIG. 4. For example, if s or w are too small (150), some or all of the channels 102 may reach critical heat flux and dry out before the fuel cell stack reaches full power. This can cause temperature gradients within a fuel cell or rapid temperature excursions and burnout. If the channels 102 are too large (152), incipience may not occur and single phase natural convection will cause a gradual temperature rise moving upward along a channel 102. If incipience occurs somewhere in the middle of a channel 102, a rapid temperature drop is observed at that point. These phenomena can occur non-uniformly within and between fuel cells. Since temperature uniformity is essential for proper operation of fuel cells, selection of appropriate flow field plate dimensions, and incorporation of surface coatings/features in accordance with the present invention, avoids the aforementioned phenomena (151).

Increasing the critical heat flux of flow field plate coolant channels can be achieved by appropriate selection of channel dimensions in addition to, or exclusive of, appropriate surface coatings and/or features, such as microporous and nanostructured features, details of which are described in the Example provided below. In general, the nanostructured features can be uniformly oriented nanostructures and/or have a predefined geometric shape. The inner channel surfaces can comprise in excess of about 1 million nanostructures/cm². For example, the inner channel surfaces can comprise in excess of about 1 billion nanostructures/cm². The nanostructured features may have lengths ranging from about 0.1 micron to about 3 micron and aspect ratios (length to mean diameter) of greater than about 3. Nanostructured features suitable for use in the present invention may comprise metal-coated whiskers of organic pigment, most preferably C.I. PIGMENT RED 149 (PR-149 perylene red). The crystalline whiskers have substantially uniform but not identical cross-sections, and high length-to-width ratios. The microporous features may comprise assemblies of microparticles, as described previously.

### EXAMPLE

An apparatus shown generally in block diagram form in FIG. 2a was used to investigate parameters within a typical flow field coolant plate. This apparatus included a 7 inch by 20 inch aluminum heater plate 1/16″ thick into which a 4 inch by 15 inch recess 1/32 inch deep was machined to accommodate 5 flat, adhesive backed KAPTON heaters (Minco Model 5466, 3″ by 4″, nominal resistance 4.1 ohm, Minco Inc., Minneapolis Minn.). The remaining recess was filled with plasticiene clay. This back surface of the heater plate was mated to a 0.75 inch Plexiglas plate of the same dimensions. A thin layer of thermal interface grease (Wakefield Thermal Compound 120-2< Wakefield Engineering, Inc. Wakefield, Mass.) mated the front surface of this plate to the back of another 1/16″ aluminum channel plate. The back of this plate had 1/32 inch deep grooves into which 0.01 inch diameter type-T thermocouples were placed, terminating at the horizontal centerline and in vertical locations that correspond with the bottom, center, and top of the active regions created by activation of 1 to 5 of the aforementioned heaters as will be explained.

The flat front of this channel plate formed the inside of the fluid channels. An adhesive backed film (3M vinyl film nominally 0.004″ thick) was applied in layers as needed to create the desired channel thickness, t. It is noted that in this disclosure, the channel thickness, t, is referred to herein interchangeably as channel depth, d. The film or film layers were cut in advance such that, when applied to the channel plate, they created interchannel ribs. The interchannel ribs were present only over the heated region. To study the effects of the channel wall surfaces, the channel plate was modified before the ribs were applied with various treatments as described in Table 1 below.

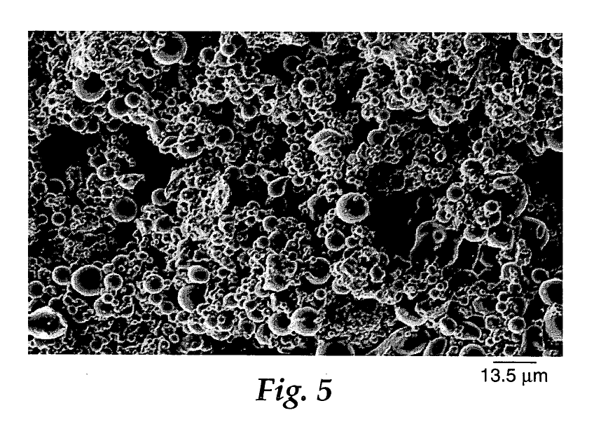

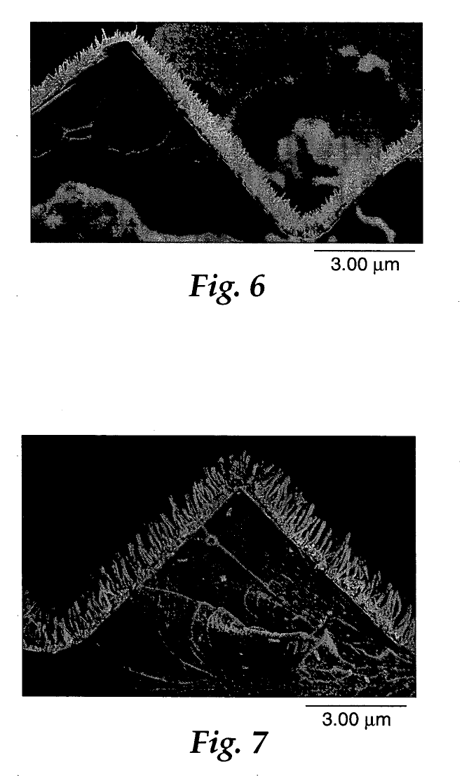

TABLE 1
Surface Treatments and Parameters Evaluated

| | | s = w | d | L |
|---|---|---|---|---|
| Surface | Description | [mm] | [mm] | [mm] |
| Bare | Smooth vinyl/aluminum | 1.59 | 0.203, 0.508 | 76, 152, 229 |
| | sheet - untreated | | | |
| Microporous | ABM coating made with 3M G- | 1.59 | 0.102, 0.203, 0.508 | 152 |
| | 200 Ceramic Microspheres (1-20 | | | |
| | micron) in place of aluminum. | | | |
| | Solvent used was methyl-t-butyl | | | |
| | ketone to limit volatility. Applied | | | |
| | lightly with an airbrush. Electron | | | |
| | micrograph in FIG. 5. | | | |
| Microchannel | 6 micron high, 12 micron pitch | 1.59 | 0.203, 0.508 | 152 |
| | micro channels oriented parallel | | | |
| | to fluid channels. Channels | | | |
| | microreplicated onto polyimide | | | |
| | substrate. Referred to as | | | |
| | Microstructured Catalyst | | | |
| | Transfer Substrate (MCTS). | | | |
| | Substrate applied to aluminum | | | |
| | plate with 3M Spray mount | | | |
| | adhesive. | | | |
| Microchannel with | Same as above but with | 1.59 | 0.203, 0.508 | 152 |
| perylene coating | perylene di-carboximide pigment | | | |
| | (Product Code PR149) | | | |
| | compound coated on surface of | | | |
| | channels | | | |
| MicroChannel w/Whiskers | Same as above but with | 1.59 | 0.203, 0.508 | 152 |
| (“nanostructured” | perylene di-carboximide | | | |
| coating) | converted to whiskers ˜0.6 | | | |
| | micron long and 270-600 | | | |
| | angstrom wide. Electron | | | |
| | micrograph in FIG. 6. | | | |
| Micro w/Pt Whiskers | Same as described above but | 1.59 | 0.203, 0.508 | 152 |
| (“nanostructured” | with platinum permalloy at a | | | |
| coating) | mass loading of 0.207 mg/cm² | | | |
| | on whiskers. Electron | | | |
| | micrograph in FIG. 7. | | | |

A similar assembly formed the second wall of the channel region. While this assembly has heaters and the same channel surface treatment as the first, ribs were not applied to it nor was it instrumented with thermocouples. Also, it contained a 0.25 inch diameter hole through which liquid entered and pairs of 0.25 inch diameter holes through which vapor exited the assembly. The plate assembly was clamped together with bolts.

The apparatus was designed to allow heated regions 4 inches wide and 76, 152, 229, 305 and 381 mm in length. The various length corresponding to the activation of heater pairs 1-5. Only the first 3 lengths were used in this study. For all lengths, liquid return was provided by a liquid return hole. This hole connected with a brass hose bard. For each length, only the two vapor passages immediately above that heated region were open to similar hose barbs. For example, the apparatus was configured for 2 heaters (heated region 6 inches high). Thus, all vapor holes were plugged except those immediately above the active region. These connected via the hose barbs to the condenser assembly.

The condenser was a conventional water-cooled shell and tube heat exchanger cooled by tap water. The manifold connecting the apparatus to the condenser had a clear section to allow viewing of the liquid height or head acting on the liquid return line. For purposes of the experiment, this was adjusted to keep the liquid head at the top of the channels or active region.

The heaters were connected in parallel as needed to a Kepco Model BOP 20-20M (20V, 20A) bipolar operational power supply/amplifier controlled via analog connection to a National Instruments Labview data acquisition system. The voltage to the heaters and the thermocouple temperature were monitored with this same data acquisition system.

The apparatus was run using Fluorinert FC-87 or perfluoropentane. This fluid boils at 29° C. and has a molecular weight of 288 g/mol. This is similar to HFE-7200 which has a molecular weight of 264 g/mol and, with a boiling point of 76° C., may be considered a preferred fluid for actual PEM fuel cells. FC-87 was used because its 30° C. boiling point minimized heat losses and stresses in the Plexiglas.

The automated data acquisition system was typically programmed to start at 4 VDC and then advance in 0.5 VDC increments every 15 minutes. Previous experiments showed that steady state was reached in this time period. At the end of each time interval, the system rapidly acquired 100 measurements, averaged them, and logged the result. The data include time of measurement, heater voltage, and top (T3), bottom (T1), and center (T2) temperatures.

The results discussed below are generally presented with wall heat flux as the independent variable. It should be noted that there are three heat fluxes one can refer to when discussing such data. The heat flux Q″_{gen} is the heat flux generated on one MEA which is the product of the current density and the cell overpotential. Assuming that there is one bipolar or cooling plate between every two adjacent MEAs, then each cooling plate will receive approximately ½ Q″_{gen} on each of its two surfaces and will dissipate a total heat flux of Q″_{gen}. The heat flux reported in the following results, Q″ is the heat flux applied to each plate surface during the experiment. Thus,
Q″˜Q″_{gen}/2 [1]

A third heat flux useful for comparison to other literature sources is the channel wall heat flux. Assuming that the ribs are roughly adiabatic, then this flux is equal to
Q″ₗᵢₜ=(w+s)Q″/w [2]

The difference between thermocouple temperatures T2 and T3 was used as a measure of temperature variation across the plate.
Temperature Variation=T3−T2[3]

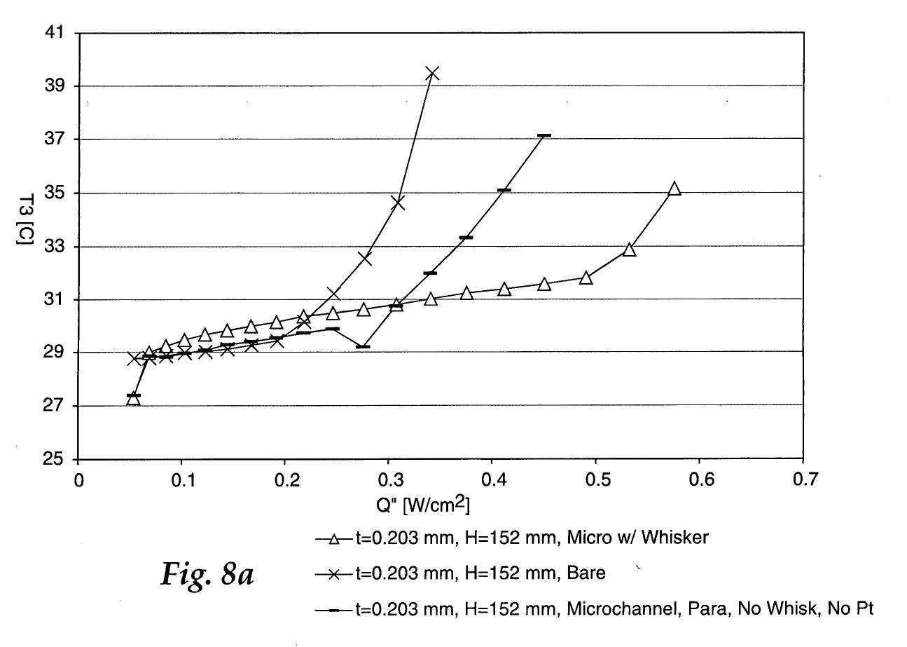

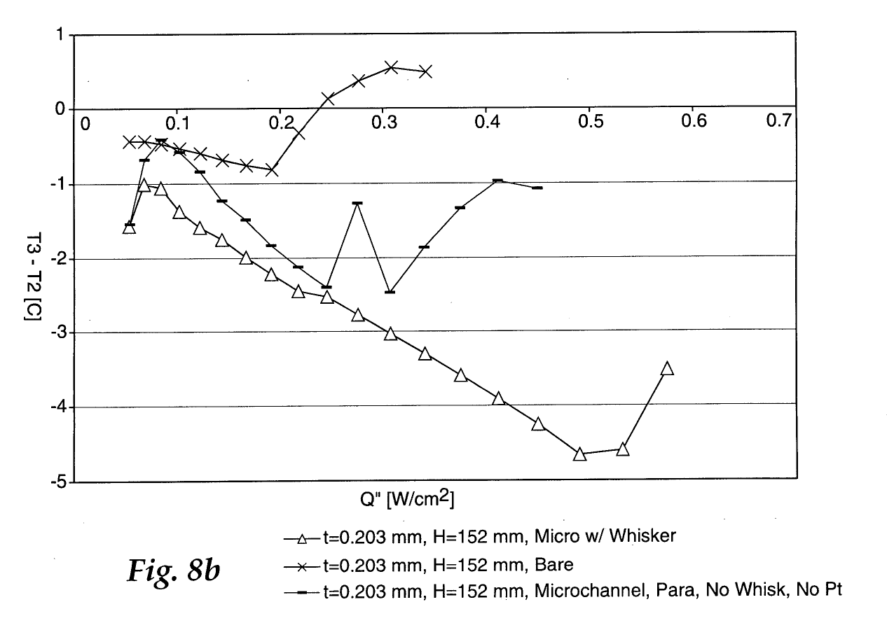

Data derived from the experimental arrangement discussed above are presented in FIGS. 8A through 12B. The Figures show average surface temperature and its spatial variation as a function of heat flux Q″ for coolant channels having the indicated dimensions and surface treatment (or no surface treatment, as in the case of bare coolant channels). As is evidenced by the data depicted graphically in FIGS. 8A through 12B, the type of coolant channel coating/features and channel dimensions significantly influence the critical heat flux. Conscientious selection of coolant channel coatings/features and dimensions in accordance with the present invention can significantly enhance the efficacy of a given cooling arrangement incorporated in flow field plates that provides dual-phase cooling along the entire length of the plate's coolant channels.

The y-axis label for FIGS. 8A-12A is temperature T3. T3 refers to the third of three thermocouples located at the top or distal end of the coolant channels. T3 is provided to show when dryout occurs. The y-axis label for FIGS. 8B-12B is the temperature difference T3−T2. T2 refers to the second of three thermocouples located at approximately the middle section of the coolant channels. The difference between T3 and T2 shows temperature non-uniformity as between the T2 and T3 temperature sensing locations of the coolant channels.

FIG. 8A shows plots of temperature versus heat flux for (1) uncoated coolant channels (bare vinyl/aluminum channels without any added surface modification), (2) coolant channels implemented to include PR-149 coated microchannels without whiskers or platinum, and (3) coolant channels implemented to include PR-149 coated microchannels with whiskers. These whiskers are referred to as a “nanostructured” feature. FIG. 8A illustrates what can be referred to as the “nanostructured effect.” As is readily seen in FIG. 8A, the nanostructured effect provides for higher critical heat flux by use of nanostructured coatings in the coolant channels. FIG. 8B shows the FIG. 8A data plotted in terms of a temperature difference at two channel length locations versus heat flux.

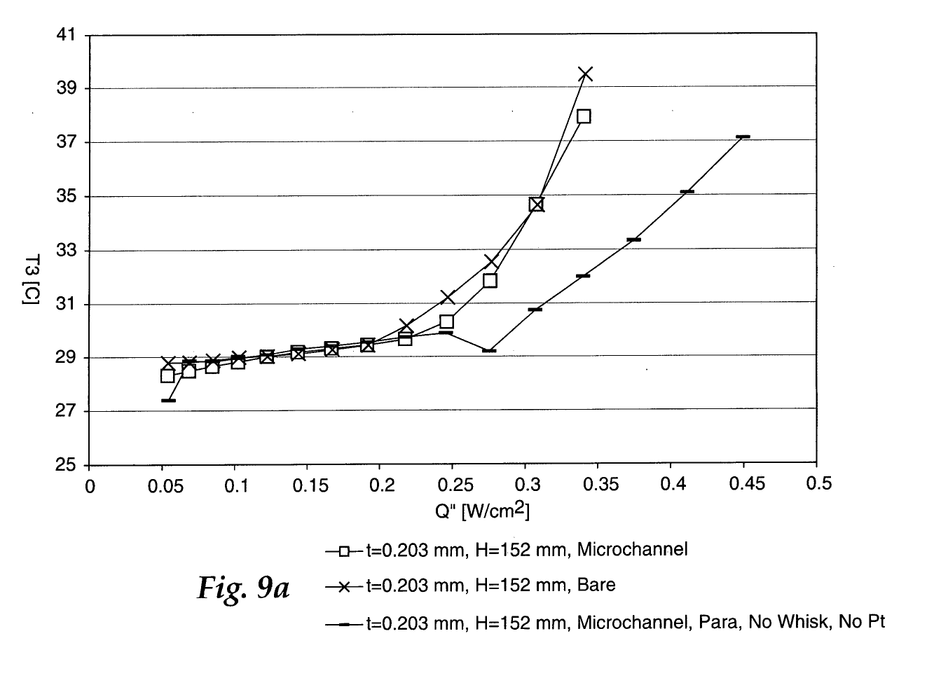

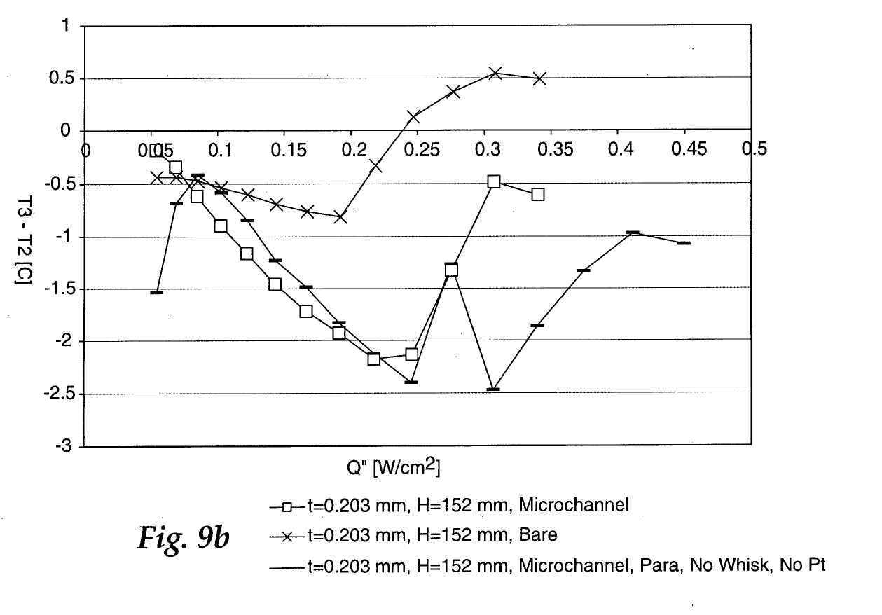

FIG. 9A shows plots of temperature versus heat flux for (1) uncoated coolant channels, (2) coolant channels implemented to include PR-149 coated microchannels without whiskers or platinum, and (3) coolant channels with microchannels implemented using a bare microstructured catalyst transfer substrate (MCTS) UV cured acrylate substrate (“sawblade” feature). FIG. 9A illustrates what can be referred to as the “van der Waals solids effect.”

As is demonstrated by the data graphically depicted in FIG. 9A, the “van der Waals solids effect” provides for higher critical heat flux by use of coatings with van der Waals solids in the coolant channels. Various useful van der Waals solids include those described in commonly owned U.S. Pat. No. 4,812,352, which is hereby incorporated herein by reference. FIG. 9B shows the FIG. 9A data plotted in terms of a temperature difference at two channel length locations versus heat flux.

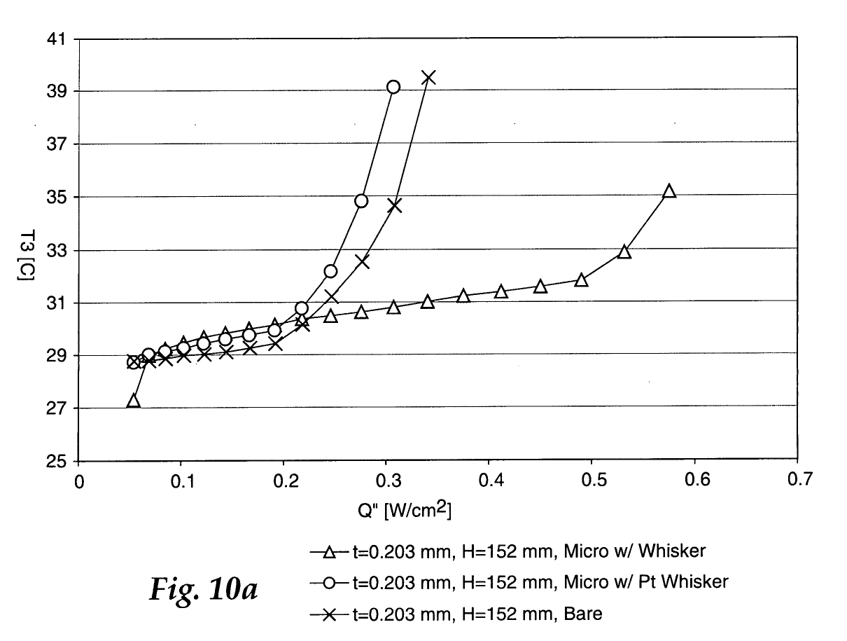

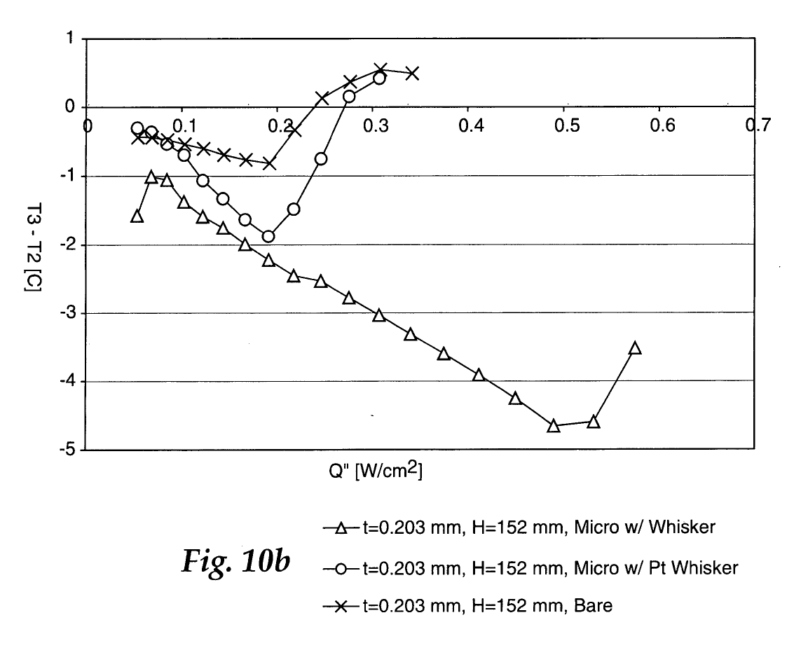

FIG. 10A shows plots of temperature versus heat flux for (1) uncoated coolant channels, (2) coolant channels implemented to include PR-149 coated microchannels with whiskers, and (3) coolant channels implemented to include microchannels with platinum whiskers. The data presented in FIG. 10A reinforces the effect of van der Waals solids on critical heat flux for a nanostructured coolant channel surface. FIG. 10B shows the FIG. 10A data plotted in terms of a temperature difference at two channel length locations versus heat flux.

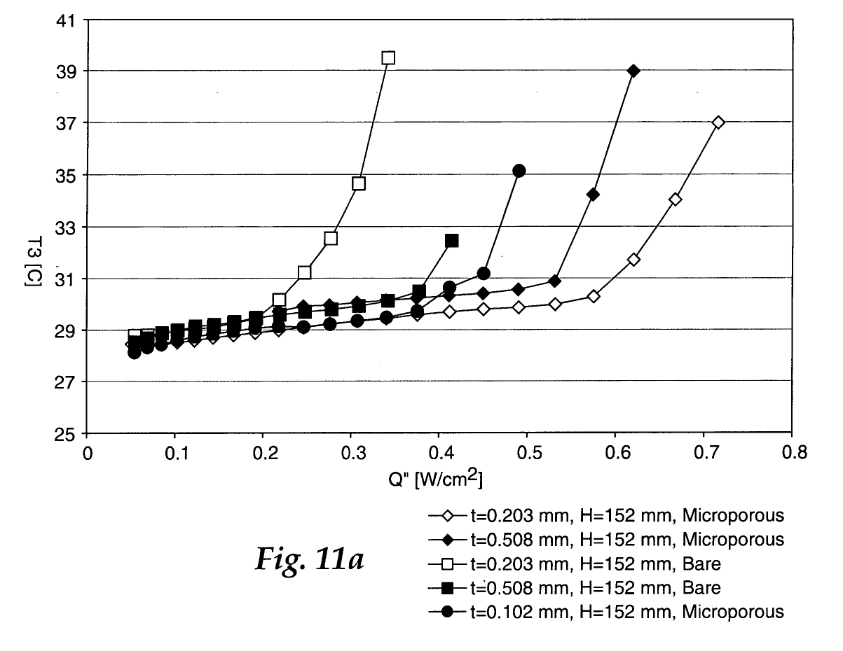

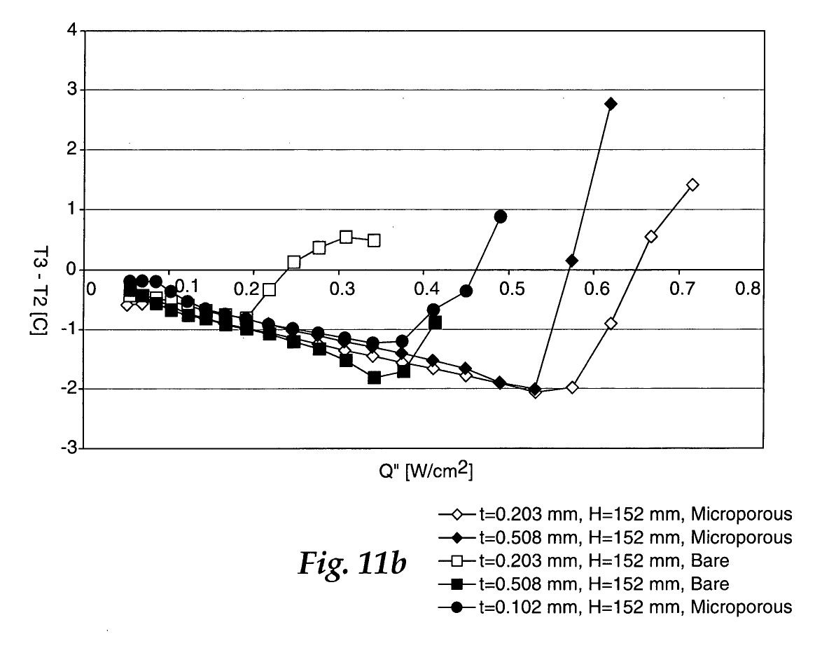

FIG. 11A shows plots of temperature versus heat flux for uncoated coolant channels of varying depth and for microporous coated coolant channels of varying depth. FIG. 11A shows that microporous coated coolant channels provide for higher critical heat flux relative to bare channels for a variety of channel depths. FIG. 11B shows the FIG. 11A data plotted in terms of a temperature difference at two channel length locations versus heat flux.

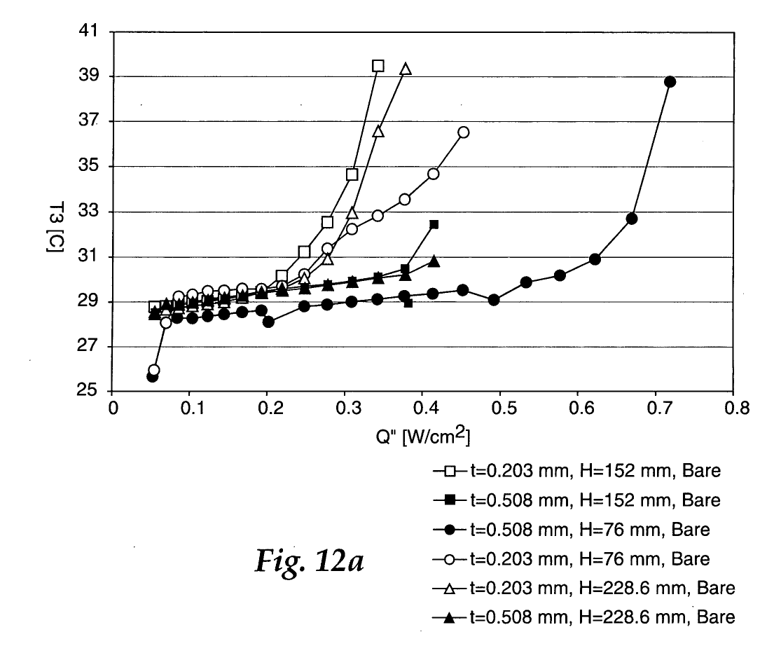

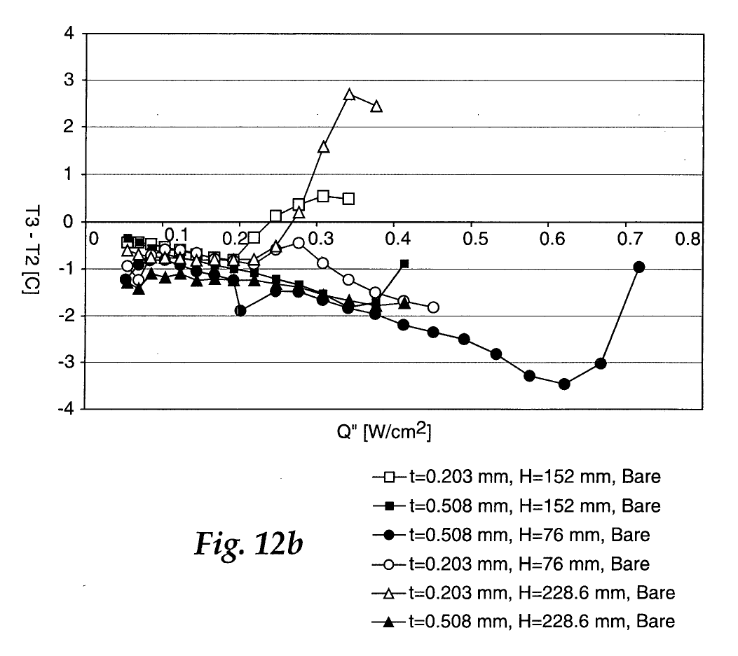

FIG. 12A shows plots of temperature versus heat flux for uncoated coolant channels of varying depths and lengths. FIG. 12A shows the effect of channel depth and length on critical heat flux. FIG. 12B shows the FIG. 12A data plotted in terms of a temperature difference at two channel length locations versus heat flux.

FIGS. 8A through 12B demonstrate that the various coatings described above, when incorporated in coolant channels of flow field plates, can extend the critical heat flux significantly. Of these coatings, the microporous coating shows the most dramatic enhancement, followed by the nanostructured coating. It can further be seen that, while the nanostructured coating delayed dryout considerably, the temperature non-uniformity is quite large. In contrast, the microporous coating significantly delayed dryout while minimizing temperature non-uniformity. It is interesting to note that the bare microchannels and the microchannels with platinum coated whiskers did not show significant enhancement. This implies a difference between the perylene and platinum surfaces. Also worth noting is that the microporous coating shows improvement when going from t=0.508 mm to t=0.203 mm. This trend does not continue when thickness is further reduced to t=0.102 mm. This implies an optimum channel thickness.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What we claim is:

1. A fuel cell stack assembly, comprising:
at least one membrane electrode assembly; and
a cooling apparatus comprising at least one flow field plate configured to facilitate essentially passive, two-phase cooling for the membrane electrode assembly, the flow field plate comprising a plurality of fluid flow channels having a channel length defined relative to a direction of coolant flow and a channel depth of less than about 1 mm, the cooling apparatus maintaining a maximum temperature gradient of less than about 0.2° C./cm in a direction of coolant flow as the membrane electrode assembly is subject to changes in heat flux to the coolant from about 0 W/cm² to about 1.5 W/cm².

2. The assembly of claim 1, wherein the plurality of channels have a depth of less than about 0.7 mm.

3. The assembly of claim 1, wherein the plurality of channels have a depth of less than about 0.5 mm.

4. The assembly of claim 1, wherein the plurality of channels have a depth of less than about 0.3 mm.

5. The assembly of claim 1, wherein the plurality of channels have a depth of about 0.1 mm.

6. The assembly of claim 1, wherein the cooling apparatus maintains the maximum temperature gradient of less than about 0.2° C./cm in the direction of coolant flow as the membrane electrode assembly is subject to changes in heat flux to the cooling from about 0 W/cm² to about 1 W/cm².

7. The assembly of claim 1, wherein the channel length is greater than about 10 cm.

8. The assembly of claim 1, wherein the plurality of channels have a channel spacing of about 1 mm to about 2 mm, a channel width of about 1 mm to about 3 mm, and the channel length ranges from about 60 mm to about 230 mm.

9. The assembly of claim 1, wherein a ratio of the channel length to channel depth ranges between about 150 and about 1100.

10. The assembly of claim 1, wherein the cooling apparatus further comprises a heat transfer fluid comprising a fluorochemical.

11. The assembly of claim 1, wherein the cooling apparatus further comprises a heat transfer fluid comprising a dielectric halocarbon.

12. The assembly of claim 1, wherein the cooling apparatus further comprises a heat transfer fluid comprising water.

13. The assembly of claim 1, wherein the cooling apparatus further comprises a heat transfer fluid comprising a hydrocarbon.

14. The assembly of claim 1, wherein the membrane electrode assembly comprises a surface configured to contact a surface of the flow field plate, and the cooling apparatus further comprises a heat transfer fluid having a boiling point at the operating pressure of less than about 3° C. below a maximum temperature of the membrane electrode assembly surface.

15. A fuel cell stack assembly, comprising:
at least one membrane electrode assembly; and
a cooling apparatus comprising at least one flow field plate configured to facilitate essentially passive, two-phase cooling for the membrane electrode assembly, the flow field plate comprising a plurality of fluid flow channels having inner channel surfaces, each of the inner channel surfaces comprising nanostructured features, the cooling apparatus maintaining a maximum temperature gradient of less than about 0.2° C./cm in a direction of coolant flow as the membrane electrode assembly is subject to changes in heat flux to the coolant from about 0 W/cm² to about 1.5 W/cm².

16. The assembly of claim 15, wherein the cooling apparatus maintains the maximum temperature gradient to less than about 0.2° C./cm as the membrane electrode assembly is subject to changes in heat flux to the coolant from about 0 W/cm² to about 1 W/cm².

17. The assembly of claim 15, wherein the nanostructured features comprise uniformly oriented nanostructures.

18. The assembly of claim 15, wherein the nanostructured features comprise nanostructures having a predefined geometric shape.

19. The assembly of claim 15, wherein the inner channel surfaces comprise in excess of about 1 million nanostructures/cm².

20. The assembly of claim 15, wherein the inner channel surfaces comprise in excess of about 1 billion nanostructures/cm².

21. The assembly of claim 15, wherein the nanostructured features have lengths ranging from about 0.1 micron to about 3 micron.

22. The assembly of claim 15, wherein the plurality of channels have a channel length of greater than about 10 cm.

23. The assembly of claim 15, wherein the cooling apparatus further comprises a heat transfer fluid comprising a fluorochemical or a dielectric halocarbon.

24. The assembly of claim 15, wherein the cooling apparatus further comprises a heat transfer fluid comprising water or a hydrocarbon.

25. The assembly of claim 15, wherein the membrane electrode assembly comprises a surface configured to contact a surface of the flow field plate, and the cooling apparatus further comprises a heat transfer fluid having a boiling point at the operating pressure of less than about 3° C. below a maximum temperature of the membrane electrode assembly surface.

26. A fuel cell stack assembly, comprising:
at least one membrane electrode assembly; and
a cooling apparatus comprising at least one flow field plate configured to facilitate essentially passive, two-phase cooling for the membrane electrode assembly, the flow field plate comprising a plurality of fluid flow channels having inner channel surfaces, each of the inner channel surfaces comprising microporous features, the cooling apparatus maintaining a maximum temperature gradient of less than about 0.2° C./cm in a direction of coolant flow as the membrane electrode assembly is subject to changes in heat flux to the coolant from about 0 W/cm² to about 1.5 W/cm².

27. The assembly of claim 26, wherein the microporous features comprise microspheres.

28. The assembly of claim 26, wherein the microporous features comprise ceramic microspheres.

29. The assembly of claim 26, wherein the cooling apparatus maintains the maximum temperature gradient to less than about 0.2° C./cm in the direction of coolant flow as the membrane electrode assembly is subject to changes in heat flux to the coolant from about 0 W/cm² to about 1 W/cm².

30. The assembly of claim 26, wherein the plurality of channels have a channel length of greater than about 10 cm.

31. The assembly of claim 26, wherein the cooling apparatus further comprises a heat transfer fluid comprising a fluorochemical or a dielectric halocarbon.

32. The assembly of claim 26, wherein the cooling apparatus further comprises a heat transfer fluid comprising water or a hydrocarbon.

33. The assembly of claim 26, wherein the membrane electrode assembly comprises a surface configured to contact a surface of the flow field plate, and the cooling apparatus further comprises a heat transfer fluid having a boiling point at the operating pressure of less than about 3° C. below a maximum temperature of the membrane electrode assembly surface.

34. A fuel cell stack assembly, comprising:
at least one membrane electrode assembly; and
a cooling apparatus comprising at least one flow field plate configured to facilitate essentially passive, two-phase cooling for the membrane electrode assembly, the flow field plate comprising a plurality of fluid flow channels having inner channel surfaces, each of the inner channel surfaces having a coating comprising a substantially planar organic molecule comprising delocalized pi-electrons, the cooling apparatus maintaining a maximum temperature gradient of less than about 0.2° C./cm in a direction of coolant flow as the electrode membrane assembly is subject to changes in heat flux to the coolant from about 0 W/cm² to about 1.5 W/cm².

35. The assembly of claim 34, wherein the organic molecule comprises chains or rings over which a density of the pi-electrons is extensively delocalized.

36. The assembly of claim 34, wherein the coating comprises van der Waals solids.

37. The assembly of claim 34, wherein the cooling apparatus maintains the maximum temperature gradient to less than about 0.2° C./cm in the direction of coolant flow as the electrode membrane assembly is subject to changes in heat flux to the coolant from about 0 W/cm² to about 1 W/cm².

38. The assembly of claim 34, wherein the plurality of channels have a channel length of greater than about 10 cm.

39. The assembly of claim 34, wherein the cooling apparatus further comprises a heat transfer fluid comprising a fluorochemical or a dielectric halocarbon.

40. The assembly of claim 34, wherein the cooling apparatus further comprises a heat transfer fluid comprising water or a hydrocarbon.

41. The assembly of claim 34, wherein the membrane electrode assembly comprises a surface configured to contact a surface of the flow field plate, and the cooling apparatus further comprises a heat transfer fluid having a boiling point at the operating pressure of less than about 3° C. below a maximum temperature of the electrode membrane assembly surface.

42. A fuel cell stack assembly, comprising:
at least one membrane electrode assembly; and
a cooling apparatus comprising a heat transfer fluid and at least one flow field plate configured to facilitate essentially passive, two-phase cooling for the membrane electrode assembly as the electrode membrane assembly is subject to changes in heat flux to the heat transfer fluid from about 0 W/cm² to about 1.5 W/cm², the flow field plate comprising a plurality of fluid flow channels, the plurality of channels having a channel depth, a channel spacing, a channel length, and a channel width, the width of the channels being less than about 5 mm;
wherein the channel width, channel spacing, channel length and channel depth are dimensioned to promote nucleated boiling of the heat transfer fluid below a critical heat flux and to prevent dryout as the heat transfer fluid passes along the length of the channels.

43. The assembly of claim 42, wherein the cooling apparatus maintains a maximum temperature gradient of less than about 0.2° C./cm in a direction of heat transfer fluid flow as the membrane electrode assembly is subject to changes in heat flux to the heat transfer fluid from about 0 W/cm² to about 1.5 W/cm².

44. The assembly of claim 42, wherein the cooling apparatus maintains a maximum temperature gradient to less than about 0.2° C./cm in a direction of heat transfer fluid flow as the membrane electrode assembly is subject to changes in heat flux to the heat transfer fluid from about 0 W/cm² to about 1 W/cm².

45. The assembly of claim 42, wherein channel width, channel spacing, channel length, and channel depth are dimensioned to promote incipience of the heat transfer fluid at an entry region of the channels and to prevent the heat flux from exceeding the critical heat flux as the heat transfer fluid passes an exit region of the channels.

46. The assembly of claim 42, wherein the length of the channels is greater than about 10 cm.

47. The assembly of claim 42, wherein the channel spacing is about 1 mm to about 2 mm, and the channel width is about 1 mm to about 3 mm.

48. The assembly of claim 42, wherein the plurality of channels have a channel length in a direction of heat transfer fluid flow of about 60 mm to about 230 mm.

49. The assembly of claim 42, wherein the plurality of channels have a channel length, and a ratio of the channel length to channel depth ranges between about 150 and about 1100.

50. The assembly of claim 42, wherein the channel depth is less than about 1 mm.

51. The assembly of claim 42, wherein the heat transfer fluid comprises a fluorochemical.

52. The assembly of claim 42, wherein the heat transfer fluid comprises a dielectric halocarbon.

53. The assembly of claim 42, wherein the heat transfer fluid comprises water or a hydrocarbon.

54. The assembly of claim 42, wherein the membrane electrode assembly comprises a surface configured to contact a surface of the flow field plate, and the heat transfer fluid has a boiling point at the operating pressure of less than about 3° C. below a maximum temperature of the membrane electrode assembly surface.

55. The assembly of claim 42, wherein plurality of fluid flow channels have inner channel surfaces, each of the inner channel surfaces comprising nanostructured features.

56. The assembly of claim 42, wherein plurality of fluid flow channels have inner channel surfaces, each of the inner channel surfaces comprising microporous features.

57. The assembly of claim 42, wherein plurality of fluid flow channels have inner channel surfaces, each of the inner channel surfaces having a coating comprising a substantially planar organic molecule comprising delocalized pi-electrons.

58. A fuel cell stack assembly, comprising:
at least one membrane electrode assembly;
at least one flow field plate in thermal contact with the membrane electrode assembly, the flow field plate comprising fluid flow channels; and
means for cooling the membrane electrode assembly by way of essentially passive, two-phase cooling as the MEA is subject to changes in heat flux to a heat transfer fluid from about 0 W/cm² to about 1.5 W/cm², the cooling means comprising means for promoting nucleated boiling of the heat transfer fluid below a critical heat flux to prevent dryout as the heat transfer fluid passes along the length of the fluid flow channels.

59. The assembly of claim 58, wherein the cooling means comprises means for maintaining a maximum temperature gradient to less than about 0.2° C./cm in a direction of heat transfer fluid flow as the membrane electrode assembly is subject to changes in heat flux to the heat transfer fluid from about 0 W/cm² to about 1.5 W/cm².

60. The assembly of claim 58, wherein the cooling means comprises means for promoting incipience of the heat transfer fluid at an entry region of the channels and for preventing the heat flux from exceeding the critical heat flux as the heat transfer fluid passes an exit region of the channels.

61. The assembly of claim 1, wherein said flow field plate additionally comprises a vapor port and a condensate port, wherein said vapor port is larger than said condensate port.

62. The assembly of claim 15, wherein said flow field plate additionally comprises a vapor port and a condensate port, wherein said vapor port is larger than said condensate port.

63. The assembly of claim 26, wherein said flow field plate additionally comprises a vapor port and a condensate port, wherein said vapor port is larger than said condensate port.

64. The assembly of claim 34, wherein said flow field plate additionally comprises a vapor port and a condensate port, wherein said vapor port is larger than said condensate port.

65. The assembly of claim 42, wherein said flow field plate additionally comprises a vapor port and a condensate port, wherein said vapor port is larger than said condensate port.

66. The assembly of claim 58, wherein said flow field plate additionally comprises a vapor port and a condensate port, wherein said vapor port is larger than said condensate port.
